(19) United States
(12) Patent Application Publication
(10) Pub. No.: US 2005/0046122 A1
(43) Pub. Date: Mar. 3, 2005

(54) Sealing arrangement, especially for sealing the shaft of a spindle

(76) Inventor: Herman H.F. Ernst, Old Saybrook, CT (US)

Correspondence Address: WILLIAM COLLARD;COLLARD & ROE, P.C., 1077 NORTHERN BOULEVARD, ROSLYN, NY, 11576, US

(21) Appl. No.: 10/489,561

(22) PCT Filed: Aug. 30, 2002
(86) PCT No.: PCT/DE02/03212

(30) Foreign Application Priority Data
Sep. 4, 2001 (DE) 101 43 344.1

(51) Int. Cl. F16J 3/00

(52) U.S. Cl. 277/628

(57) ABSTRACT

The invention relates to a sealing arrangement, especially for sealing a spindle shaft which is rotatingly accommodated in a housing, comprising a stationary stator element which forms at least one cavity for receiving a seal in conjunction with a rotating rotor element which is especially fixed to the spindle shaft, the cavity being formed by at least one opening with a channel of the sealing arrangement in order to discharge liquid entering into the cavity upon rotation of the rotor element. At least one other stator element, which seals the rotor element in relation to the stator element when the rotor element is in a stationary position, is also provided.

The invention relates to a sealing arrangement, in particular for sealing a spindle shaft accommodated in a rotary manner in a housing, comprising a stationary stator element which, together with a rotating rotor element, in particular fastened to the spindle shaft, forms at least one cavity for accommodating a seal, the cavity being formed via at least one opening with a passage of the sealing arrangement for discharging liquid which has entered the cavity during the rotation of the rotor element.

Static seals in the form of chamber or labyrinth seals are known as prior art for sealing parts rotating relative to one another and in particular a shaft of a spindle. Alternatively, or in addition, sealing-air arrangements with encircling nozzle rings are used.

Furthermore, WO 99/49246 discloses dynamic sealing systems in which a plurality of seals are arranged in a cavity between a rotor element and a stator element of a sealing arrangement. Furthermore, the cavity is connected via at least one opening to an (inlet) passage of the seal in order to discharge again any liquids which have entered the cavity. Such dynamic sealing systems develop their sealing effect only during a relative movement between rotor element and stator element. When rotor element and stator element are stationary, no sealing or only inadequate sealing is achieved.

The object of the invention is to provide a sealing arrangement which offers improved sealing in both the static and the dynamic application.

The object is achieved by a sealing arrangement having the features of the characterizing part of patent claim 1 in combination with the features of the preamble of patent claim 1. Advantageous embodiments of the sealing arrangement are described in subclaims 2 to 7.

In the sealing arrangement according to the invention, in addition to a sealing arrangement disclosed, for example, by WO 99/49246, a chamber seal or a labyrinth seal, at least one further sealing element is provided which seals the rotor element relative to the stator element when rotor element is stationary. Sealing by the sealing arrangement is thus also achieved in the stationary state.

According to an advantageous embodiment, the further sealing element is reliably accommodated in position in a recess of the rotor element of the sealing arrangement.

The recess advantageously has a (clearance) region for accommodating the further sealing element, which is expanded in radial direction in particular by centrifugal forces which occur. In this case, the further sealing element can reduce or neutralize its sealing effect when centrifugal forces occur, the dynamic sealing effect still being ensured by the seal arranged in the cavity of the sealing arrangement. A further improvement in the sealing properties of the sealing arrangement according to the invention is achieved if the stator element has an in particular obliquely running contact surface which serves as a sealing surface for the further sealing element. The oblique profile of the contact surface enables contact to be made over a large area by the adjacent further sealing element with increased applied pressure.

In an elastic design of the further sealing element, the further sealing element, when the rotor element is rotating, is expanded by the centrifugal forces produced and lifts in particular from the contact surface of the stator element, as a result of which the sealing between rotor element and stator element is neutralized. In the rotating state, this sealing is also no longer required, or is only required to a reduced extent, since, in the rotating state of the sealing arrangement, dynamic sealing is achieved by the seal in the cavity between rotor element and stator element. When the speed between rotor element and stator element is reduced and the rotation finally stops, the centrifugal forces which occur are reduced, and the further sealing element again abuts against the respective contact surfaces while exerting its sealing effect, the sealing between stationary rotor element and stator element again being achieved.

According to the invention, the further sealing element used is an O-ring known per se, which encloses, for example, the shaft of a motor spindle. Such an O-ring consists in particular of a rubber mixture, e.g. of a fluororubber (“Viton”, code designation “FKM” according to ISO 1629) or acrylonitrile-butadiene rubber (“Perbunan NT”, code designation NBR according to ISO 1629).

The further sealing element, in addition to a round cross section (e.g. in the case of an O-ring), may also have other cross sections (e.g. approximately square or rectangular/polygonal and may also be formed, for example, from the specified material as a Quad-Ring known per se.

The invention is explained in more detail with reference to exemplary embodiments in the figures of the drawing, in which:

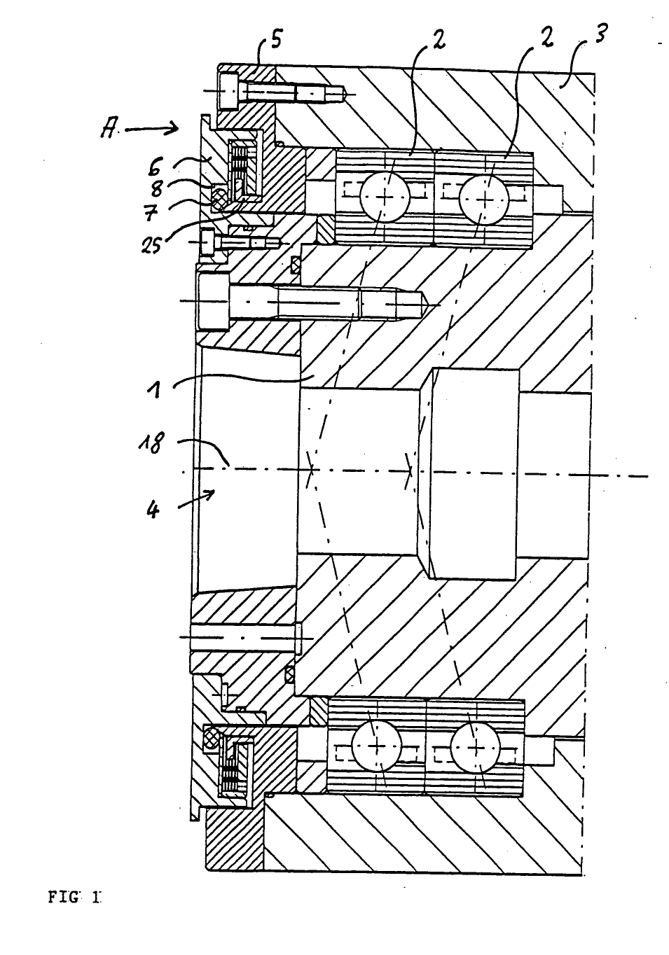

FIG. 1 shows a sectional view of the end region of a shaft of a spindle with a sealing arrangement according to the invention,

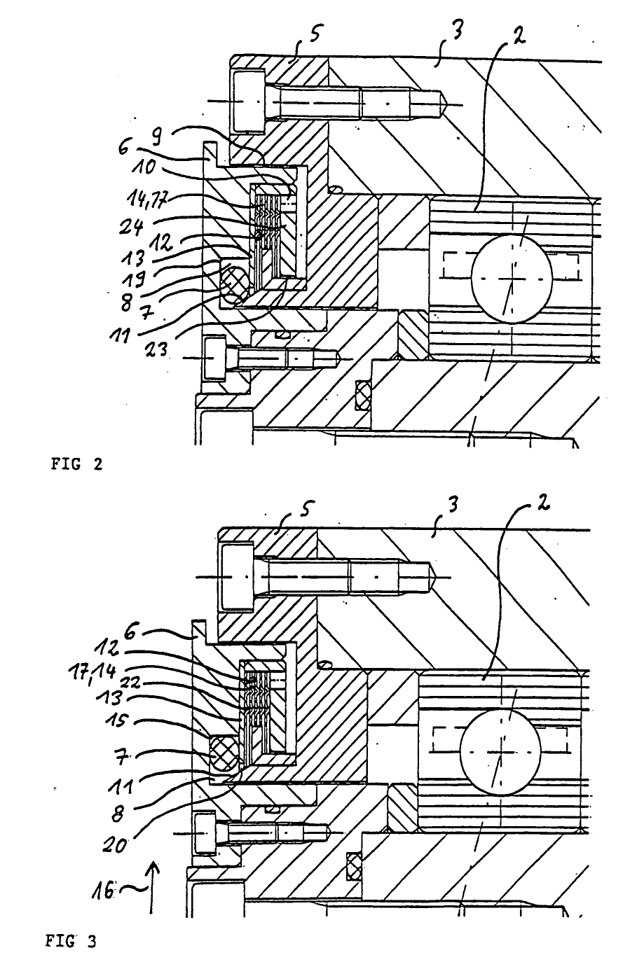

FIG. 2 shows a detailed illustration of the sealing arrangement according to FIG. 1 in the stationary state,

FIG. 3 shows a detailed illustration of the sealing arrangement according to FIG. 1 in the rotating state,

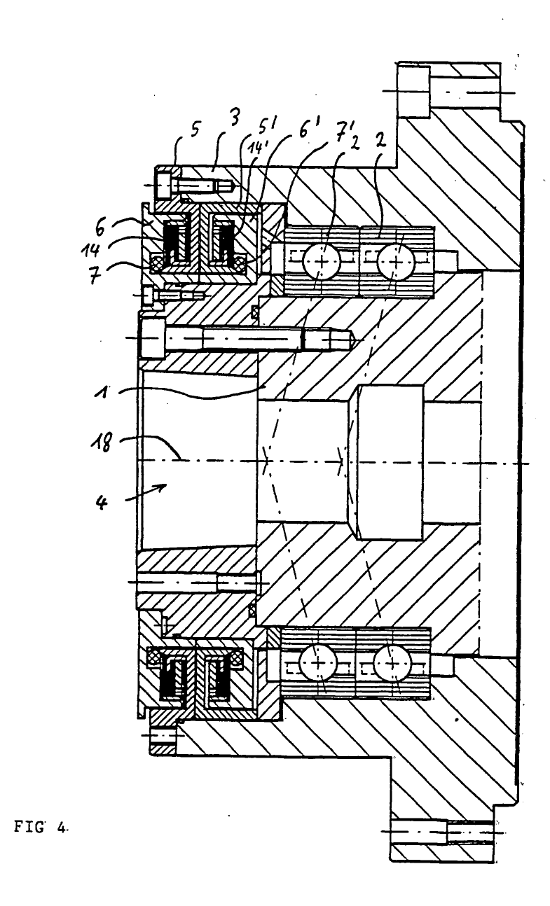

FIG. 4 shows a sectional view of the end region of a shaft of a spindle with two sealing arrangements according to the invention (double seal), and

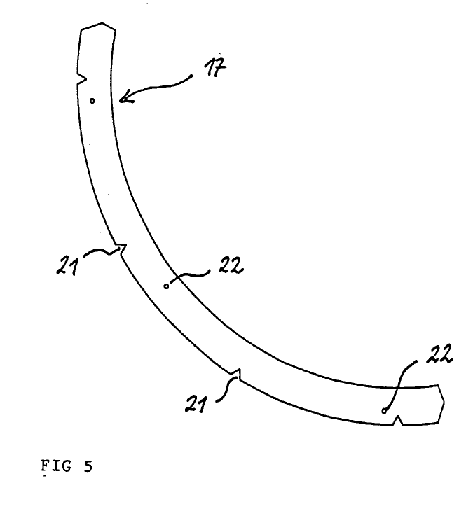

FIG. 5 shows a partial view A of a sealing ring of a seal of a sealing arrangement according to FIG. 1.

FIG. 1 shows a sectional view of an end region of a spindle shaft 1 which is accommodated in a housing 3 of a spindle via in particular grease-lubricated bearing elements 2. The spindle shaft 1 is designed as a hollow shaft and has an opening 4, e.g. for accommodating tools or tool clamping elements (not depicted in any more detail). Furthermore, FIG. 1 shows a sectional view of a sealing arrangement arranged in an encircling manner and having a stator element 5 with associated angle 25 and having a rotor element 6 with a recess 8 in which a further sealing element 7 for sealing the stator element 5 relative to the rotor element 6 when spindle shaft 1 is stationary is accommodated. Further details of the sealing arrangement according to FIG. 1 can be seen from the enlarged illustrations according to FIG. 2 and FIG. 3.

According to FIG. 2, a seal 14 known per se is arranged in a cavity 12 between stator element 5 and rotor element 6, this seal 14 consisting in particular of sealing rings 17 (cf. FIG. 5) described, for example, in WO 99/49246. Any liquid entering the cavity 12 of the sealing arrangement through the passage 9 and the connection 23 is directed back out of the cavity 12 again into the passage 9 via the opening 10 of the component 24 of the rotor element 6 by the function, described in WO 99/49246, of the seal 14. A dynamic sealing effect is thus achieved relative to stationary stator element 5 when rotor element 6 is rotating.

The seal 14 may also be designed as a labyrinth or chamber seal known per se (not depicted in more detail).

In the illustration according to FIG. 2, i.e. when rotor element 6 is stationary relative to the stator element 5, the further sealing element 7 (e.g. an O-ring or a Quad-Ring) bears against a contact surface 11 of the stator element 5, as a result of which static sealing between stator element 5 and rotor element 6 is achieved. The contact surface 11 of the stator element runs obliquely to the axis 18 of the spindle shaft 1. For the sealing, the sealing element 7 makes contact with the contact surface 11 of the stator element 5, the wall 19 of the recess 8 and the separating element 15 of the rotor element 6. All the parts of the sealing arrangement—unless shown differently—are of rotationally symmetrical and encircling design.

When rotor element 6 is rotating, i.e. when shaft 1 of the spindle is driven, centrifugal forces occur, as a result of which the further sealing element 7, in particular of elastic design, is subjected to a force acting outward in radial direction 16, shifts into the region 15 of the recess 8 and assumes the outer position depicted in FIG. 3, this outer position being lifted from the contact surface 11. The sealing function of the further sealing element 7 relative to the stator element 5 and the rotor element 6 is thus neutralized and the opening 20 between the separating element 13 and the contact surface 11 is cleared. The dynamic sealing effect is now ensured solely by the seal 14 in the cavity 8. Due to the lifting of the further sealing element 7 when rotor element 6 is rotating, the further sealing element 7 is accommodated in the recess 8 in such a way that it is subject to a low rate of wear.

In this case, the further sealing element 7 serves for the static sealing. To reduce wear, the further sealing element 7 lifts by utilizing the centrifugal forces which occur during the rotation, as a result of which the sealing function is reduced and finally neutralized. During a reduction in the speed, the centrifugal forces also decrease, so that the further sealing element 7 again approaches said reference surfaces and finally completely seals the latter when stationary.

In the sealing arrangement according to the invention, a dynamically sealing seal 14 in the cavity 12 is therefore combined with a statically sealing seal 7 in the recess 8.

FIG. 4 shows a spindle shaft 1 which is sealed with two sealing arrangements and which can be used, in particular, in the case of oil-lubricated bearing elements 2 in order to prevent an escape of bearing oil. Components of the second sealing arrangement which correspond to those of the first sealing arrangement are provided, as corresponding elements, with reference numerals provided with a prime.

FIG. 5 shows a partial view of a sealing ring 17 having notches 21 and bulges 22 all the way round; the latter serve for the spaced-apart accommodation of a plurality of sealing rings 17 in the cavity 12 for forming a seal 14. In this case, the sealing rings 17 are accommodated in the rotor element 6 and rotate with the latter, e.g. during rotation of the spindle shaft 1.

The sealing arrangement according to the invention offers special advantages when used in a tool spindle, in particular having an automatic tool change system, since an ingress of foreign particles and liquid from outside is also reliably prevented when spindle shaft 1 is stationary (e.g. during the tool change) and the further sealing element 7 is not subjected to any wearing friction when spindle shaft 1 is rotating.

In general, the expression “spindle” is to be interpreted universally and may relate in the practical embodiment to, for example, a motor spindle, a belt spindle or a gear spindle, etc.

Designations

1 Spindle shaft
2 Bearing element
3 Housing
4 Opening
5 Stator element
6 Rotor element
7 Further sealing element
8 Recess
9 Passage
10 Opening
11 Contact surface
12 Cavity
13 Separating element
14 Seal
15 Region
16 Radial direction
18 Axis
19 Wall
20 Opening
21 Notch
22 Bulge
23 Connection
24 Component
25 Angle

1. A sealing arrangement, in particular for sealing a spindle shaft accommodated in a rotary manner in a housing, comprising a stationary stator element which, together with a rotating rotor element, in particular fastened to the spindle shaft, forms at least one cavity for accommodating a seal, the cavity being formed via at least one opening with a passage of the sealing arrangement for discharging liquid which has entered the cavity during the rotation of the rotor element, characterized in that at least one further sealing element (7) is provided which seals the rotor element (6) relative to the stator element (5) when the rotor element (6) is stationary.

2. The sealing arrangement as claimed in claim 1, wherein the further sealing element (7) is arranged in a recess (9) of the rotor element (6).

3. The sealing arrangement as claimed in claim 2, wherein the recess (9) has a region (15) for accommodating the further sealing element (7), which is expanded in radial direction (16) in particular by centrifugal forces which occur.

4. The sealing arrangement as claimed in claim 1, wherein the stator element (5) has an in particular obliquely running contact surface (11) for making contact with the further sealing element (7) when the rotor element (6) is stationary.

5. The sealing arrangement as claimed in claim 1, wherein the further sealing element (7) is of elastic design for expansion during increasing centrifugal forces and for contraction during decreasing centrifugal forces.

6. The sealing arrangement as claimed in claim 1, wherein the further sealing element (7) is designed as an O-ring.

7. The sealing arrangement as claimed in claim 6, wherein the O-ring consists of a rubber mixture.
